(19) United States
(12) Patent Application Publication
(10) Pub. No.: US 2026/0225193 A1
(43) Pub. Date: Aug. 6, 2026

(54) ADJUSTMENT OF TURBINE ENGINE PART

(71) Applicant: SAFRAN AIRCRAFT ENGINES, Paris (FR)

(72) Inventors: Charlie Noël Nathan ARTAUD, Moissy-Cramayel (FR); Paul René François JOYEUX, Moissy-Cramayel (FR); Mickaël ANZEMBERG, Moissy-Cramayel (FR); Patrick GASCHER, Moissy-Cramayel (FR)

(73) Assignee: SAFRAN AIRCRAFT ENGINES, Paris (FR)

(21) Appl. No.: 19/151,038

(22) PCT Filed: Jan. 23, 2024
(86) PCT No.: PCT/FR2024/050091

§ 371 Date: Jul. 25, 2025

(30) Foreign Application Priority Data
Jan. 27, 2023 (FR) FR2300793

(51) Int. Cl. B23P 6/00; F01D 25/00

(52) U.S. Cl. CPC B23P 6/002; F01D 25/00; F05D 2230/10

(57) ABSTRACT

A method for adjusting a turbine engine part to be placed in a gas flow path of the turbine engine, the part having previously undergone an operation of adding material to fill a defect in at least one zone of its surface, resulting in an excess thickness in the at least one zone of its surface, including the steps of controlling formation of a three-dimensional image of the part, identifying the at least one zone of the part surface including the excess thickness, and identifying the excess thickness, in the three-dimensional image of the part, determining a trajectory of an adjustment tool, according to the geometry of the identified excess thickness, and controlling adjustment of the part according to the determined trajectory.

### TECHNICAL FIELD

The present invention relates generally to the repair of turbine engine parts. More particularly, it relates to the removal of material, or adjustment, carried out after resurfacing with material to repair a turbine engine part.

### PRIOR ART

In particular, high-pressure turbine parts are considered, in particular nozzles belonging to the turbine stator. These parts are formed of nickel superalloy and are subjected to very high stresses during flight phases. These parts operate at very high temperatures, up to approximately 1,100° C., and are subjected to thermal fatigue forces.

These stresses cause wear of these parts, resulting in crack formation on the surface of the parts.

The repair of cracks comprises resurfacing with material by diffusion brazing to fill the gaps then removing brazing excess thicknesses in order to restore the part to its original aerodynamic profile. Currently, this material removal operation, or adjustment, is carried out manually. Its duration is approximately one hour thirty minutes per part.

This operation is therefore time-consuming and can cause substantial musculoskeletal disorders in operators.

FR 3 116 456 describes a method for repairing a turbine engine part wherein a worn zone of a part, particularly the worn leading edge of a blade of a one-piece bladed disk, is machined.

### DISCLOSURE OF THE INVENTION

The invention aims to solve the problems of the prior art by providing a method for adjusting a turbine engine part to be placed in a gas flow path of the turbine engine, the part having previously undergone an operation of adding material to fill a defect in at least one zone of its surface, resulting in an excess thickness in the at least one zone of its surface, characterized in that it comprises steps of:
controlling formation of a three-dimensional image of the part,
identifying the at least one zone of the part surface including the excess thickness, and identifying the excess thickness, in the three-dimensional image of the part,
determining a trajectory of an adjustment tool, according to the geometry of the identified excess thickness, and
controlling adjustment of the part according to the determined trajectory.

Thanks to the invention, it is possible to automatically generate a material removal trajectory adapted to each part according to the excess thicknesses to be removed. The invention allows adaptation to the variability of the input condition of the parts to be adjusted. Indeed, the position of the excess thicknesses on the part is unpredictable. Moreover, the invention makes it possible not to interfere with the healthy material of the part.

The invention is particularly adapted for parts with complex geometry such as aircraft engine high-pressure turbine parts.

The invention makes it possible to limit the onset of substantial musculoskeletal disorders in operators and free operators from time-consuming operations in favor of other operations with greater added value.

According to a preferred feature, the step of identifying the at least one zone of the part surface including the excess thickness, and identifying the excess thickness comprises:
pre-detecting irregularity on the part surface, then, in the event of the pre-detection of at least one irregularity,
filtering data representing the at least one irregularity to produce zone data wherein the data representing the at least one irregularity has been deleted, referred to as healthy zone data,
surface reconstruction performed by a function having a continuous slope, on the basis of the healthy zone data to produce reconstructed surface data corresponding to a surface without excess thickness,
comparing the actual part surface data with the reconstructed surface data, and, according to the result of the comparison, identifying the excess thickness.

According to a preferred feature, the three-dimensional image of the part comprises a mesh which represents the actual part composed of mesh elements and pre-detecting irregularity on the part surface comprises identifying first mesh elements with a curvature exceeding a curvature threshold as irregularities.

According to a preferred feature, pre-detecting irregularity on the part surface further comprises identifying second mesh elements adjacent to the first mesh elements on a predetermined number of rows.

According to a preferred feature, the function having a continuous slope is defined by a polynomial equation.

According to a preferred feature, the step of identifying the at least one zone of the part surface including the excess thickness, and identifying the excess thickness comprises an adjustment between a model of the part and the three-dimensional image of the part. This feature is implemented in the event of a substantially curved zone, in addition to the features disclosed above.

According to a preferred feature, determining a trajectory of an adjustment tool comprises comparing a predetermined trajectory with the coordinates of the points of the identified excess thickness, so as to only retain the points of the programmed trajectory for which the distance with the points of the defect is less than a comparison threshold.

According to a preferred feature, controlling adjustment of the part according to the determined trajectory comprises detecting a first contact of the tool with the excess thickness and controlling the tool so that it performs a progressive descent in successive passes.

The invention also relates to a system for adjusting a turbine engine part to be placed in a gas flow path of the turbine engine, the part having previously undergone an operation of adding material to fill a defect in at least one zone of its surface, resulting in an excess thickness in the at least one zone of its surface, the adjustment system comprising a three-dimensional measuring device and an adjustment machine, the adjustment system being characterized in that it comprises a control module capable of:
controlling the three-dimensional measuring device to form a three-dimensional image of the part,
identifying the at least one zone of the part surface including the excess thickness, and identifying the excess thickness, in the three-dimensional image of the part,
determining a trajectory of an adjustment tool, according to the geometry of the identified excess thickness, and
controlling the adjustment machine to adjust the part according to the determined trajectory.

The advantages of the system are similar to those described above.

In a particular embodiment, the steps of the method according to the invention are implemented by computer program instructions.

Consequently, the invention also relates to a computer program on an information medium, this program being likely to be implemented in a computer, this program comprising instructions adapted to the implementation of the steps of a method as described above.

The invention also relates to a computer-readable information medium, and comprising computer program instructions adapted to implementing the steps of a method as described above.

### BRIEF DESCRIPTION OF THE DRAWINGS

Further features and advantages will become apparent upon reading the following description of a preferred embodiment, given by way of non-limiting example, described with reference to the figures wherein:

FIG. 1 illustrates a system for adjusting a mechanical part according to a preferred embodiment of the invention.

FIG. 2 illustrates the method for adjusting a mechanical part according to a preferred embodiment of the invention.

FIG. 3 illustrates a step of identifying at least one zone of the part surface including an excess thickness, and identifying the excess thickness, comprised in the method of FIG. 2.

FIGS. 4a, 4b, 4c and 4d illustrate a surface reconstruction step, comprised in the method of FIG. 2.

FIG. 5 illustrates an example of a trajectory generated according to a preferred embodiment of the invention.

Identical, similar or equivalent parts of the various figures bear the same numerical references so as to facilitate the transition from one figure to another.

The various parts shown in the figures are not necessarily shown according to a uniform scale, to make the figures more readable.

The various possibilities (variants and embodiments) must be understood as not being exclusive of each other and can be combined with each other.

### DETAILED DISCLOSURE OF PARTICULAR EMBODIMENTS

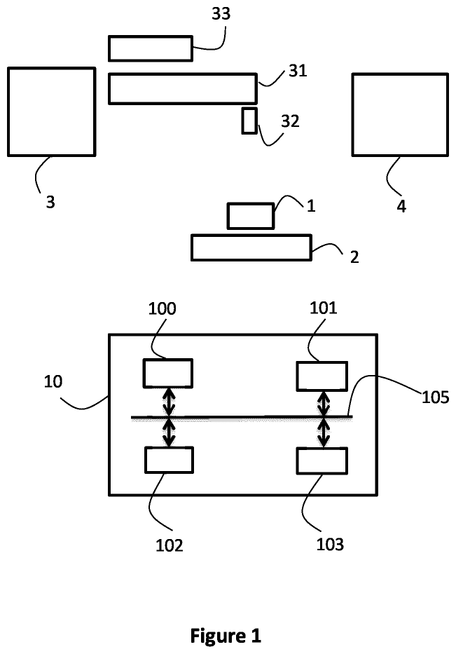

According to a preferred embodiment shown in FIG. 1, a system for adjusting a mechanical part is for example intended to adjust parts to be placed in a gas flow path of the turbine engine. The mechanical part is a high-pressure turbine part, particularly a nozzle belonging to the turbine stator.

A mechanical part 1 which has previously undergone an operation of adding material due to crack formation on its surface is considered. Adding material to the part causes an excess thickness relative to the initial geometry of the part. The purpose of the adjustment is to remove this excess thickness and to restore the part to its initial geometry, or at least to restore it to an aerodynamically suitable profile, without localized excess thicknesses.

The adjustment system comprises a support 2 adapted to receive and hold the part to be adjusted 1. The support can be movable so as to be able to provide the part to be adjusted with different positions.

The adjustment system also comprises an adjustment machine 3 which itself comprises a robotic arm 31 configured to be able to move along several axes.

The robotic arm 31 is adapted to be equipped with an adjustment tool 32. Preferably, several adjustment tools can equip the robotic arm, for example comprising abrasives with a surface having grains, the grain size of which is different from one abrasive to another, so as to carry out different tasks such as cutting, grinding, sanding and smoothing. Preferably, an automatic tool changer 33 equips the adjustment machine 3 so as to equip the robotic arm 31 with the most suitable adjustment tool 32.

The adjustment system also comprises a three-dimensional measuring device 4, for example by photogrammetry. The three-dimensional measuring device 4 is capable of performing a three-dimensional measurement of the part to be adjusted 1.

The adjustment system also comprises a control module 10 which controls the different elements of the adjustment system described above. The control module 10 has the general structure of a computer. It particularly comprises a processor 100 executing a computer program implementing the method according to the invention, a memory 101, input interfaces 102 and output interfaces 103.

These different elements are conventionally connected by a bus 105.

The input interfaces 102 are connected to the different elements described above and are intended to receive information therefrom.

The processor 100 executes the processing operations which will be described hereinafter. These processing operations are carried out in the form of computer program code instructions which are stored by the memory 101 before being executed by the processor 100.

The memory 101 can furthermore store the results of the processing operations performed.

The output interfaces 103 are connected to the different elements described above and are intended to send them instructions.

To simplify the representation, the different mechanical and electrical connections of the elements described above have not been shown in FIG. 1.

The operation of the adjustment system is ensured by the control module 10 and is detailed in the form of a method described hereinafter.

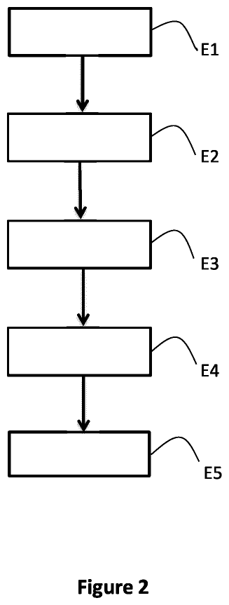

FIG. 2 shows the method for adjusting a mechanical part according to one embodiment of the invention. The adjustment method comprises steps E1 to E5 implemented by the control module 10 described above.

It is assumed that a part 1 such as a high-pressure turbine stator nozzle of an aircraft engine has previously undergone an operation of adding material due to crack formation on its surface. Adding material results in an excess thickness relative to the original part surface. This excess thickness is a defect of the part.

It is also assumed that the part 1 has been fastened to the support 2. This is the part to be adjusted.

Step E1 is controlling the three-dimensional measuring device 4 to measure the part to be adjusted 1, for example by photogrammetry, and form a three-dimensional image thereof.

To do this, the part is scanned and then polygonized. This produces a mesh which represents the actual part composed of basic elements, here of triangular type. The theoretical profile of the surface considered is continuous, which implies that the mesh elements that form it have substantially the same characteristics.

The three-dimensional image data thus produced is stored in memory.

The next step E2 is processing of the three-dimensional image to identify the zone(s) of the part 1 comprising material additions, i.e. excess thicknesses. The excess thicknesses per se are also identified. Correlatively, the zones not comprising excess thickness are also identified. In further processing, only the zones with excess thickness are processed, and zones without excess thickness are excluded from processing and left intact. In other words, processing is reserved only for zones having excess thicknesses.

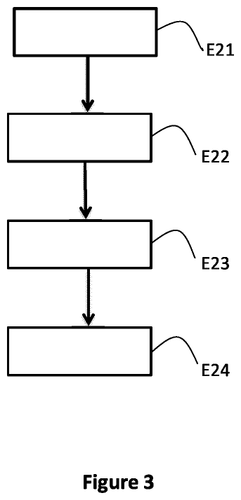

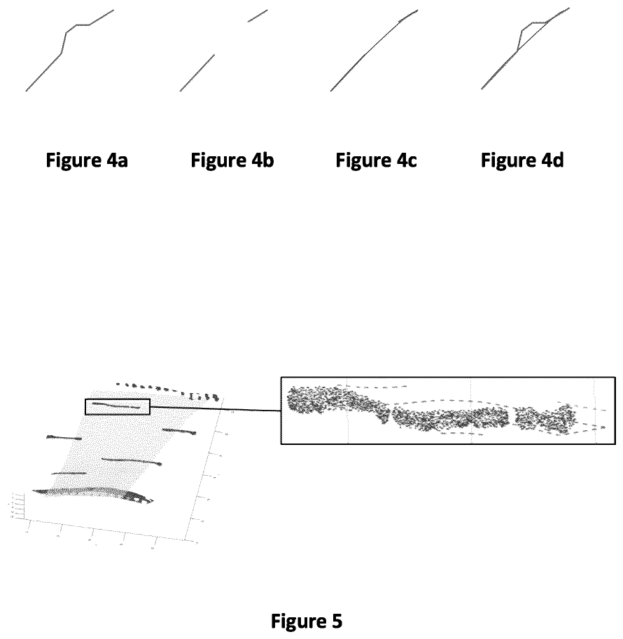

Step E2 is described with reference to FIGS. 3 and 4a to 4d and comprises sub-steps E21 to E24.

FIGS. 4a to 4d show a search zone of a healthy zone wherein an excess thickness is located. The zone has for example a diameter between 10 and 20 mm, for example 15 mm. Indeed, among all the types of brazing excess thicknesses, none have dimensions greater than 15 mm in all directions. Such a search zone size therefore makes it possible to systematically have healthy zones. This dimension also makes it possible to strike a balance between the following factors: processing time (non-linear), overlap between the different zones so as not to omit any zones, double analyses generated (time-consuming redundancy), etc.

Sub-step E21 is a pre-detection of irregularities on the mechanical part surface. An irregularity is shown in FIG. 4a. It can consist of an excess thickness to be processed or another irregularity not processed within the scope of the invention, such as a cooling hole present in the air flow path.

For this purpose, the curvature of the mesh elements is analyzed. During a first selection, mesh elements with a curvature exceeding a configurable curvature threshold are identified as irregularities. The curvature threshold particularly varies according to the zones of the part analyzed.

Preferably, a second selection is made to also select the mesh elements adjacent to the mesh elements identified as irregularities, on a number of rows for example equal to 5. The number of rows is determined empirically and can be configurable.

The set of selected mesh elements is the set of pre-detected irregularities. It is assumed hereinafter that at least one irregularity has been detected.

The next sub-step E22 is filtering the pre-detected irregularities with the aim of deleting them from the three-dimensional image data.

Filtering the irregularities results in surface zone data wherein the irregularity data has been deleted (FIG. 4b).

The surface zone data after defect filtering thus identifies a so-called healthy zone.

The next sub-step E23 is a surface reconstruction at the part surface zone deleted, on the basis, on either side, of the healthy zone located around the deleted zone. The reconstruction is performed by a function having a continuous slope, for example defined by a polynomial equation. The polynomial equation is for example of degree 5, or higher, which makes it possible in practice to obtain good quality results.

Thus, the reconstruction uses the healthy zone surface data determined in the previous step and its result is reconstructed surface data corresponding to a defect-free surface (FIG. 4c).

The next sub-step E24 is comparing the actual part surface data with the reconstructed surface data in the zone considered (FIG. 4d).

The comparison is used to isolate the mesh portion corresponding to the excess thickness. This step allows identification and characterization of the excess thickness located in the zone considered.

For a given excess thickness, the result of step E2 is a dataset representing the excess thickness, referred to as excess thickness data, and a dataset representing the zone including the excess thickness. The data is typically point coordinates. For example, the excess thickness data is point coordinates of the given excess thickness. It is possible to associate an excess thickness value with each point considered.

It should be noted that in some highly curved zones, and for patch-type repairs, the curvature of the basic elements (elementary triangles) is already substantial even in the absence of irregularities. In this case, using the curvature of the basic elements of the mesh for pre-detecting irregularity on the part surface (sub-step E21) may not be optimal. For these zones, an alternative method for identifying and characterizing an excess thickness (step E2) can be an adjustment between a model of the part and the three-dimensional image of the part. This adjustment can be carried out between a portion of the model of the part (model corresponding to the theoretical geometry of the part, given by its CAD representation) and a portion of the actual surface measured. Such a local (rather than overall) adjustment makes it possible to avoid any deformations of the part relative to its theoretical CAD (in particular relative deformations, of a portion of the part relative to another portion of the part, for example of the driving blade relative to the driven blade). However, this method is less effective on seams and protruding defects in air flow paths. In the example of a method described here, for the most curved zones of the part (leading edge for example), this alternative method is used instead of the surface reconstruction method described above with reference to FIGS. 4a to 4b.

Step E2 is followed by step E3 which is determining a trajectory of the adjustment tool 32. Step E3 is described for a detected excess thickness, or defect, in a given zone, and is repeated for all the excess thicknesses detected on the part considered.

The part has been pre-processed by CAD/CAM software, so as to produce a programmed trajectory. The programmed trajectory is a machining trajectory which would result, after machining, in a surface corresponding to the surface of the theoretical, CAD, model of the part.

The programmed trajectory is compared with the coordinates of the defect points of the zone considered. Each point of the programmed trajectory and each point of the defect are compared, with a comparison threshold, so as to only retain the points of the programmed trajectory for which the distance with the points of the defect is less than the comparison threshold. The threshold value is for example between 0.1 and 0.3 mm.

It is possible to perform local realignments, between a portion of the CAD geometry and the actual geometry, in order to avoid any deformations generating deviations between the theoretical CAD geometry and the actual geometry of the part, in particular relative deformations of a portion of the part relative to another portion of the part, and thus reposition the trajectory to be made. This makes it possible to improve tool positioning precision relative to the part.

Alternatively, the CAM computation of the tool trajectory is performed on the basis of the reconstructed surface (without excess thickness), obtained at the end of sub-step E23 and which is based on the actual geometry measured rather than on the theoretical CAD basis. The computing complexity is greater, but the precision is increased since this makes it possible to avoid any deformations of the part.

The points thus retained form a trajectory of the adjustment tool, as illustrated in FIG. 5. FIG. 5 shows a mechanical part surface portion comprising defects. For one of the defects, the generated trajectory is shown by dotted lines.

The next step E4 is controlling the adjustment machine 3 so that it adjusts the part according to the determined trajectory of the adjustment tool 32.

Optionally, in particular when the programmed trajectory is obtained based on the theoretical CAD modeling of the part and without local realignment, the first contact of the tool with the excess thickness can be detected, for example with a wattmeter. The tool is then controlled to perform a progressive descent, in successive passes, for example with a vertical increment between 0.01 and 0.05 mm, indeed even between 0.02 and 0.03 mm. This detection of contact followed by progressive descent makes it possible to avoid errors, in the programmed trajectory, due to deformations of the actual part relative to its theoretical CAD modeling.

Step E4 comprises selecting an adjustment tool 32 and controlling the tool changer 33 so that it equips the adjustment arm 31 with the selected adjustment tool 32.

Step E4 can comprise the successive use of two adjustment tools, a first tool being intended to carry out coarse material removal and a second tool being intended to perform soft abrasion to produce a smooth surface. Of course, the number of successive tools can be greater than two, with each tool producing finer abrasion than the previous one.

The next step E5 is inspecting the machined part.

According to a first variant, the inspection is carried out visually by an operator, for example during a manual finishing operation following machining.

According to a second variant, the three-dimensional measuring device 4 is controlled to measure the part 1 after adjustment, for example by photogrammetry, and forms a three-dimensional image thereof. This step is similar to step E1. The image formed is analyzed to check the conformity of the adjustment result with an expected result.

1-11. (canceled)

12. A method for adjusting a turbine engine part to be placed in a gas flow path of the turbine engine, the part having previously undergone an operation of adding material to fill a defect in at least one zone of its surface, resulting in an excess thickness in the at least one zone of its surface, the method comprising steps of:
controlling formation of a three-dimensional image of the part,
identifying the at least one zone of the part surface including the excess thickness, and identifying the excess thickness, in the three-dimensional image of the part,
determining a trajectory of an adjustment tool, according to the geometry of the identified excess thickness, and
controlling adjustment of the part according to the determined trajectory.

13. The method for adjusting a part according to claim 12, wherein the step of identifying the at least one zone of the part surface including the excess thickness, and identifying the excess thickness comprises:
pre-detecting irregularity on the part surface, then, in the event of the pre-detection of at least one irregularity,
filtering data representing the at least one irregularity to produce zone data wherein the data representing the at least one irregularity has been deleted, referred to as healthy zone data,
surface reconstruction performed by a function having a continuous slope, on the basis of the healthy zone data to produce reconstructed surface data corresponding to a surface without excess thickness,
comparing the actual part surface data with the reconstructed surface data, and, according to the result of the comparison, identifying the excess thickness.

14. The method for adjusting a part according to claim 13, wherein the three-dimensional image of the part comprises a mesh which represents the actual part composed of mesh elements and pre-detecting irregularity on the part surface comprises identifying first mesh elements with a curvature exceeding a curvature threshold as irregularities.

15. The method for adjusting a part according to claim 13, wherein pre-detecting irregularity on the part surface further comprises identifying second mesh elements adjacent to the first mesh elements on a predetermined number of rows.

16. The method for adjusting a part according to claim 13, wherein the function having a continuous slope is defined by a polynomial equation.

17. The method for adjusting a part according to claim 12, wherein the step of identifying the at least one zone of the part surface including the excess thickness, and identifying the excess thickness comprises an adjustment between a model of the part and the three-dimensional image of the part.

18. The method for adjusting a part according to claim 12, wherein determining a trajectory of an adjustment tool comprises comparing a predetermined trajectory with the coordinates of the points of the identified excess thickness, so as to only retain the points of the programmed trajectory for which the distance with the points of the defect is less than a comparison threshold.

19. The method for adjusting a part according to claim 12, wherein controlling adjustment of the part according to the determined trajectory comprises detecting a first contact of the tool with the excess thickness and controlling the tool so that it performs a progressive descent in successive passes.

20. A system for adjusting a turbine engine part to be placed in a gas flow path of the turbine engine, the part having previously undergone an operation of adding material to fill a defect in at least one zone of its surface, resulting in an excess thickness in the at least one zone of its surface, the adjustment system comprising a three-dimensional measuring device and an adjustment machine, the system comprising a control module capable of:
controlling the three-dimensional measuring device to form a three-dimensional image of the part,
identifying the at least one zone of the part surface including the excess thickness, and identifying the excess thickness, in the three-dimensional image of the part,
determining a trajectory of an adjustment tool, according to the geometry of the identified excess thickness, and
controlling the adjustment machine to adjust the part according to the determined trajectory.

21. A computer program comprising instructions for executing the steps of the method according to claim 12 when said program is executed by a computer.

22. A computer-readable recording medium on which a computer program comprising instructions for executing the steps of the method according to claim 12 is saved.
